(19) United States
(12) Patent Application Publication
(10) Pub. No.: US 2023/0368126 A1
(43) Pub. Date: Nov. 16, 2023

(54) SYSTEM AND METHOD FOR RETURN MAIL PROCESSING

(71) Applicant: The Imagine Group, LLC, Shakopee, MN (US)

(72) Inventors: Glen M. Swyers, Charlotte, NC (US); Michael Terrence Broderick, Charlotte, NC (US); Laurel Susannah Brown, Charlotte, NC (US); Andrew Loflin, Troutman, NC (US)

(73) Assignee: The Imagine Group, LLC, Shakopee, MN (US)

(21) Appl. No.: 18/197,665

(22) Filed: May 15, 2023

Related U.S. Application Data
(60) Provisional application No. 63/341,709, filed on May 13, 2022.

(51) Int. Cl. G06Q 10/0837

(52) U.S. Cl. CPC G06Q 10/0837

(57) ABSTRACT

A novel and advantageous system and method for return mail processing is provided. Particularly, the present disclosure relates to a novel and advantageous system and method for return mail processing and improving data hygiene. More particularly, the present disclosure relates to a novel and advantageous system and method for return mail processing that creates a database of addresses and continually or periodically updates the database using post-return revisions. In further embodiments, the system and method may apply business rules for making the revisions and/or for using addresses from the database. Further, the system and method may generate a scorecard of the addresses in the database that may be used in conjunction with business rules.

### CROSS-REFERENCE TO RELATED APPLICATIONS

The present disclosure claims priority to Provisional Application No. 63/341,709, entitled Systems and Method for Return Mail Processing, and filed May 13, 2022, the content of which is hereby incorporated by reference herein its entirety.

### FIELD OF THE INVENTION

The present disclosure relates to a novel and advantageous system and method for return mail processing. Particularly, the present disclosure relates to a novel and advantageous system and method for return mail processing and improving data hygiene. More particularly, the present disclosure relates to a novel and advantageous system and method for return mail processing that creates a database of addresses and continually updates the database using post-return revisions.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Undeliverable and returned mail is an expensive problem. Each year, there are 5.9 billion pieces of mail in the United States that are deemed undeliverable because the address is bad—Undeliverable As Addressed (UAA). UAA mail is all mail that cannot be delivered to the name and address specified on the mailpiece, and must be forwarded, returned to sender, or properly treated as waste, as authorized for the class of mail and ancillary service endorsement on the mailpiece.

The actions required to process UAA mail create additional cost for the United States Postal Service (USPS) and have an impact on postal operations. The impact of UAA mail to the mailing industry and the USPS is approximately $21B.

A major contributor to the prevalence of UAA mail is the percentage of people who move and do not fill out Change of Address forms with the USPS. Each year, approximately 40 million people, about 14 percent of the United States population, move at least once. Of these, only about 30% complete a Change of Address form. Another contributor to UAA mail is death of an addressee.

One method by which the USPS addresses the problem of UAA mail is to sort the mail prior to delivery. Sorting is done electronically by the USPS. Mailing addresses are scanned with optical character recognition (OCR). If the mailing address is recognized, the mail is allowed to proceed. If it is not recognized, it is returned to the sender. While pre-mailing sorting is effective in identifying mail that is mis-addressed or incompletely addressed, that type of UAA mail accounts for only about 33% of UAA mail, or 33% of the data hygiene optimization opportunity.

The USPS offers a data feed to mailing entities that provides electronic information about returned mail—also referred to as an “electronic service requested” service. This platform is a method of getting notice that a mail piece was not delivered without having the expense of returning the physical mail piece; to return a direct mail piece costs 92 cents. The electronic service requested is an electronic ACS. The data feed includes a mail piece serial number, a reason code, and an updated address, if available. While the data feed has some usefulness, the mail piece serial number from the USPS is not correlated to a mailing entity's mailing database and the data feed is limited to only Full-Service Automation mailings, which can be less than 50% of the mail volume for some clients. Further, if the mailing bar code is compromised, the mail must be physically returned.

Alternatively, or additionally, a mailing entity can physically receive returned mail. If a mailing entity opts to receive the physical mail pieces, the entity typically manually processes the returned mail and has someone manually enter the data to update the mailing database.

Thus, there is a need in the art for a more efficient and cost effective way to handle returned mail.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one embodiment, a method for return mail processing is provided. The method may include building a database of profiles, wherein each profile has an associated input address, reviewing the input addresses for accuracy, identifying an input address needing correction, and revising any identified input address such that all addresses in the database are standardized addresses. Reviewing the input addresses for accuracy may comprise confirming that each input address includes all necessary address information. The method may further include mailing a mailpiece to a standardized address, receiving a returned mailpiece having an associated undeliverable standardized address, and making a post-return recommendation regarding the profile with the undeliverable standardized address.

The post-return recommendation may be to revise the undeliverable standardized address to a revised address and further comprising revising the undeliverable standardized address to the revised address. In some embodiments, a correct address is done for the returned mailpiece and wherein the revised address is the correct address. Revising the undeliverable standardized address may be done using information form a USPS Secure Data Feed, Move Updates, or NIXIE label. Alternatively, the post-return recommendation may be to delete the profile with the undeliverable standardized address.

Revising the profile with the undeliverable standardized address is based on business rules. The business rules may be geography specific. For example, the business rule may be that if a person associated with a profile has moved out of a geographic region, the profile is deleted from the database. In one embodiment, the business rule is that a mailpiece is sent to an undeliverable standardized address at least two times before the profile is deleted.

In a further embodiment, a method for return mail processing and lifecycle data hygiene is provided. The method comprises building a database of profiles, wherein each profile has an associated input address pre-mailing sorting, mailing a mailpiece to a standardized address, and post-mailing updating. The database may be used by a plurality of mailing entities.

Pre-mailing sorting may comprise reviewing the input addresses for accuracy, identifying an input address needing correction, and revising any identified input address such that all addresses in the database are standardized addresses. Post-mailing updating may comprise receiving a returned mailpiece having an associated undeliverable standardized address, and revising the profile with the undeliverable standardized address. Revising the profile with the undeliverable standardized address may comprise deleting the profile from the database. Alternatively, revising the profile with the undeliverable standardized address may comprise revising the undeliverable standardized address to a revised address. A search for a correct address may done for the returned mailpiece and the revised address is the correct address.

In yet another embodiment, a method for return mail processing is provided. The method includes building a database of reference addresses, developing a mailing list of recipient addresses, checking the mailing list against the database of addresses and flagging recipient addresses that do not match a reference address. Building the database of addresses may comprise inputting a plurality of profiles, each profile having an associated address. The method further includes mailing a plurality of pieces of mail, each of the plurality of pieces of mail being addressed to recipient addresses in the mailing list, receiving a plurality of pieces of returned mail either physically or electronically, identifying and flagging the recipient address of each of the plurality of pieces of returned mail, and using business rules to process the flagged recipient addresses. Processing the flagged recipient addresses may comprise searching for updated addresses and the method may further comprise updating a reference address corresponding to a flagged recipient address with the updated address for the flagged recipient address. The method may further comprise resending the piece of mail to the updated address.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 illustrates an overview flow chart 10 of creating, maintaining, and using a mailing database, in accordance with one embodiment.

FIG. 2 illustrates a lifecycle of data hygiene for return mail processing, in accordance with one embodiment.

FIG. 3a illustrates an example NIXIE label.

FIG. 3b illustrates an example NIXIE label.

FIG. 4 illustrates a process flow of a method for return mail processing in accordance with one embodiment.

FIG. 5 illustrates a block diagram of a return mail processing system, in accordance with one embodiment.

### DETAILED DESCRIPTION

The present disclosure relates to a novel and advantageous system and method for return mail processing. Particularly, the present disclosure relates to a novel and advantageous system and method for return mail processing and improving data hygiene. More particularly, the present disclosure relates to a novel and advantageous system and method for return mail processing that creates a database of addresses and continually or periodically updates the database using post-return revisions. In further embodiments, the system and method may apply business rules for making the revisions and/or for using addresses from the database. Further, the system and method may generate a scorecard of the addresses in the database that may be used in conjunction with business rules.

The present disclosure provides a system, method, and computer program for building and maintaining a mailing database. The system and method for return mail processing relates to lifecycle data hygiene. Data hygiene refers to the quality of the data being used. The disclosed system and method continuously or periodically evaluate and update mailing information, including information relating to the quality of the data, used by a mailing entity is continuously improved. In some embodiments, the database may be shared across a plurality of mailing entities such that a bad address need only be processed once among such entities.

The system and method for return mail processing creates and uses a database against which mailings can be compared. The database is updated with post-return revisions. Post-return revisions may be based on paper returns or electronic returns, both discussed below. The system and method thus use a pre-mailing evaluation wherein the database for pre-mailing evaluation is continuously or periodically updated and the data hygiene is improved. The database may be used across a plurality of mailing entities or may be specific to one mailing entity, depending on business rules, privacy concerns, and applicable laws for any given mailing entity. The system and method provide a platform that assembles multiple sources of updated addresses and transforms them into a format that mailing entities can quickly and efficiently leverage.

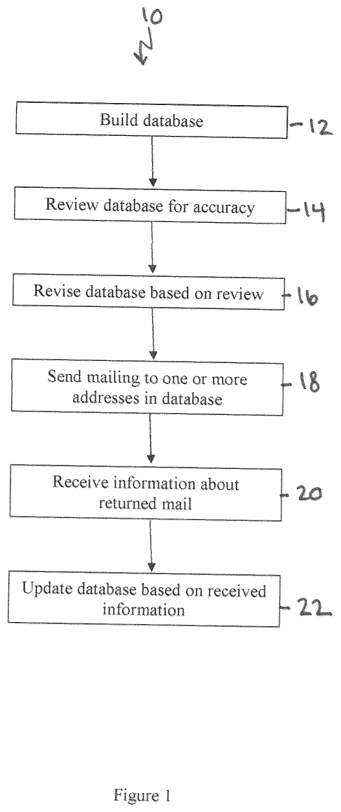

FIG. 1 illustrates an overview flow chart 10 of creating, maintaining, and using a mailing database, in accordance with one embodiment. In various embodiments, steps in this process may be done manually, may be automated, or may be semi-automated. A database of addresses is built 12. This may be done using information that a mailing entity has regarding its existing or potential customers, clients, or other. More specifically, one or more profiles are entered into the database with an address associated with each profile.

The database may include a working database and an in-use database. For example, updates to profiles and addresses may be done in the working database and may not be updated in the in-use database until approved. Alternatively, updates may be made in the in-use database and a separate working database may not be provided.

The input data is reviewed for accuracy 14. This may include, for example, confirming that all necessary information for each address (number, street name, city, state, and zip code, for example) is included, that the city, states, and zip codes align, etc. The database is revised based on this review 16. More specifically, if errors or incomplete data is identified, the input data may be corrected. After reviewing for accuracy and making any required corrections or deletions to the database, all addresses are considered standardized addresses. Mail may then be sent to one or more of the standardized addresses in the database 18.

After mail has been sent, some of the mail may be deemed undeliverable. The system receives information regarding the undeliverable, or returned, mail 20. The database is then updated based on this information 22. This may include, for example, deleting entries with bad addresses, or correcting a bad address. Correction may be done based on identifying a new address using one or more sources for address information. Mailing-entity specific business rules may be applied for updating the database and/or for updating a profile or an address, discussed more fully below.

In one embodiment, the created database may be used by a plurality of mailing entities. The database may comprise a master database of reference addresses. The database may be built as discussed with reference to FIG. 1. When preparing a mailing, a mailing entity may develop a mailing list of recipient addresses. Each recipient address may be checked against the master database of reference addresses. Any recipient addresses that do not match a reference address may be flagged. The flagged addresses may be reviewed either for correction (to a standardized address) or for addition to the master database. Such method further comprises mailing a plurality of pieces of mail, each of the plurality of pieces of mail being addressed to recipient addresses in the mailing list, receiving a plurality of pieces of returned mail either physically or electronically, and identifying and flagging the recipient address of each of the plurality of pieces of returned mail. These flagged addresses may be reviewed for correction or deletion from the mailing list and/or the master database.

In some embodiments, building the master database of addresses comprises inputting a plurality of profiles, each profile having an associated address. Processing the flagged recipient addresses may comprise searching for updated addresses, and the method may further comprise updating a reference address corresponding to a flagged recipient address with the updated address for the flagged recipient address. In some embodiments, the piece of mail may be re-sent to the updated address.

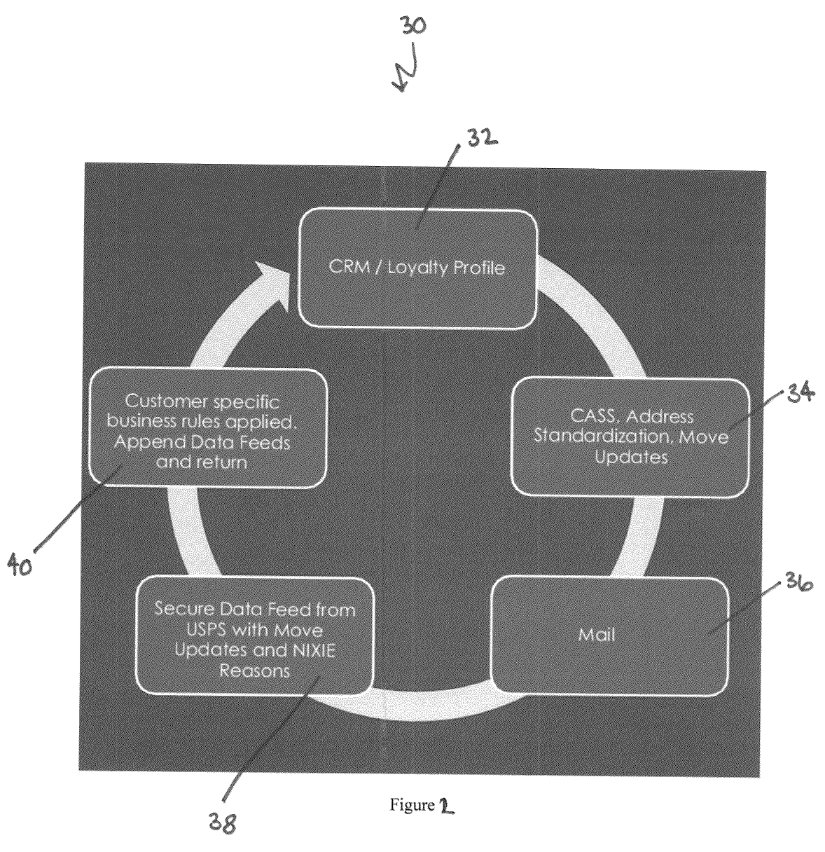

FIG. 2 illustrates the steps of FIG. 1 as a lifecycle of data hygiene for return mail processing 30, in accordance with one embodiment. The data comprises mailing information for use by a mailing entity. The system and method disclosed herein creates a database with such mailing information and continually or periodically updates the mailing information to improve data hygiene. Mail sent by the mailing entity is thus less likely to be repeatedly returned.

As shown, the cycle starts with creating one or more profiles 32. The profile may include, for example, customer relationship information. The profile is the genesis of the address for a mailing entity. For example, if the mailing entity is a bank, the profile may relate to a banking client and may include information given to the bank by the banking client. The one or more profiles, including an address for each profile, may be input into a database. As initially input into the system, the addresses may be referred to as input addresses.

The input addresses may be reviewed for accuracy. Based upon this review, the input addresses may be updated 34. This may comprise, for example, reviewing the input addresses using information from the USPS such as information from the Coding Accuracy Support System (CASS) used by the USPS to certify the accuracy of addresses and postal codes. This may further include address standardization information and move updates. The updating may include updating based on Proprietary Change of Address (PCOA) information that may be garnered from commercially available services. In some situations, it may not be possible to correct an address (for example, if city, state, and zip code cannot be correlated) and the associated profile may be deleted or may be flagged for review. The addresses after this step (including revised input addresses and input addresses not needing correction) may be referred to as standardized addresses.

When a mailing entity chooses to do a mailing, mail is sent to one or more profiles using the standardized addresses 36. The mail is processed by the USPS and either delivered or returned as undeliverable. When mail is returned, the USPS typically provides some sort of information. This information may be provided via an “electronic service requested” service wherein a mailing entity receives notice that a mail piece was returned without receiving the physical mail piece back. The data feed provides a mail piece serial number, a reason code, and an updated address.

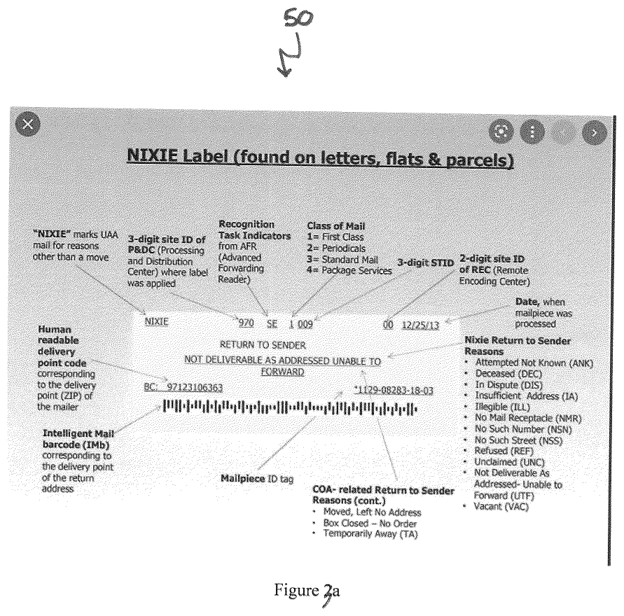

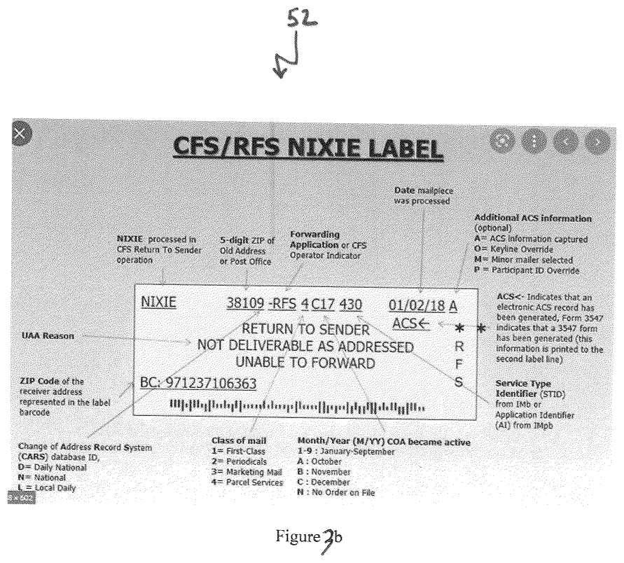

If the physical mailpiece is returned to the mailing entity, it is generally returned with a NIXIE label. Example NIXIE labels 50 and 52 and associated information contained therein are shown in FIGS. 3a and 3b. FIG. 3a illustrates a NIXIE label that is used on letters, flats, and parcels. FIG. 3b illustrates a CFS/RFS NIXIE label. The NIXIE label can include information about why the mailpiece was returned—such as missing forwarding information, missing or invalid secondary information (such as apartment or suite number), addressee deceased, etc.

If a mailpiece is returned, the associated profile may be updated. More specifically, post-return revisions may be recommended. For example, a recommendation may be made to delete a profile from the database, updating the standardized address to a revised address (such as adding an apartment number if one is determined), or other. The post-return revision recommendations may be based on information from the USPS Secure Data Feed, Move Updates, and/or NIXIE reasons.

Mailing-entity specific business rules may be applied for updating the database and/or for updating mail based on the updates to the database, discussed more fully below. The database may be updated with post-return revisions based on these business rules. More specifically, a loyalty profile or CRM of a client may be updated. Business rules applied to returned mail may be specific to a mailing entity. As discussed more fully below, the business rules may be directed to a mailing entity's geographic reach, the ability to revise a bad address, a mailing entity's legal duty for numbers of attempted delivery, etc.

The system and method may provide an automated or semi-automated workflow for return mail processing. The system and method for return mail processing and lifecycle data hygiene includes both pre-mailing sorting and post-mailing updating. Pre-mailing comprises the initial review of addresses for accuracy and revising the input addresses to standardized addresses or deleting profiles with input addresses that cannot be fixed. This filters out a percentage of addresses. That being said, some mailing entities are required to attempt at least one delivery of an item regardless of knowledge of the accuracy of the address (for example, banks).

Post-mailing updates may be done based on both physical return mail pieces and the USPS data feed. Physical return mail pieces may be scanned to capture document information. Electronic information from the USPS data feed is correlated to internal information of the mailing entity, to specific data points for updating a specific loyalty profile. More specifically, a mailing entity knows the serial number of a mail piece that they mailed. Because the mailing entity mailed the piece, the information in the mailing entity's profiles may be correlated to the bar code and the associated standardized address.

Any addresses determined as undeliverable and assessed by physical return mail review or electronic information review may be flagged as requiring updating or removal.

Once flagged, business rules may be applied. For example, business rules may include finding a better address for any flagged addresses using a PCOA process. If a change of address is found, the standardized address may be revised to a revised address and the returned mail may be remailed. If a new address is not found or if a new address does not seem correct, the profile may be flagged for further research.

In some embodiments, a transformation step may be done to change the data into a format that meets a mailing entity's unique database requirements and is presented in a real-time secure web portal.

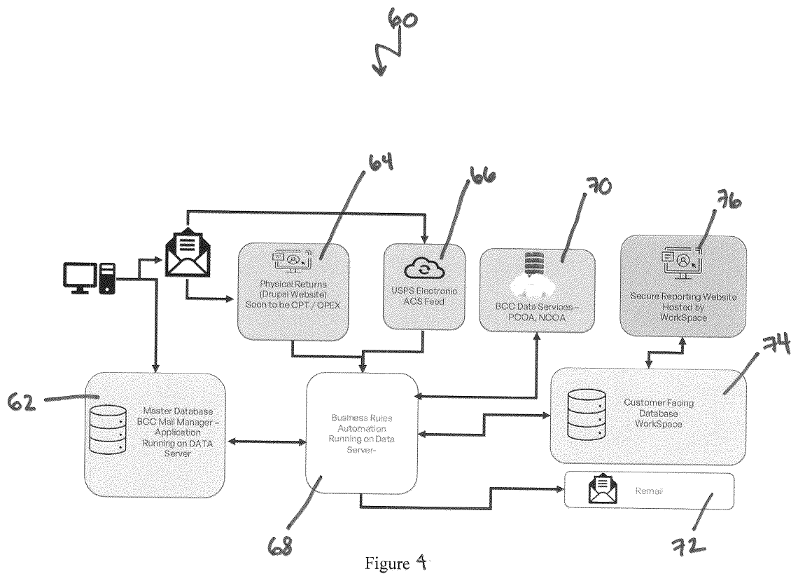

FIG. 4 illustrates a process flow 60 of a system and method for return mail processing in accordance with one embodiment.

A database for addresses is provided 62. This database may be specific to a single mailing entity or may be used by (and updated with information from) a plurality of mailing entities. The database may include addresses associated with profiles of clients of a mailing entity. These addresses may be referred to as input addresses. The input addresses for a mailing may be cross-checked with the database for reviewing accuracy of the address and an address may be updated to a standardized address if a required correction is identified and implemented.

When mail is returned, information relating to the undeliverable address may be gathered from the physical return 64 or from the USPS electronic ACS feed 66. This information may be used to flag a profile as needing updating or removal.

The flagged profile may be assessed using business rules 68. Based on the business rules, the system may look for an updated address 70 from, for example, a PCOA service provider or a National Change of Address (NCOA) from the USPS. If an updated address is found, the database may be updated and the standardized address changed to a revised address with the new information. Based on the business rules, the mail may be remailed using the revised address 72. For example, if a mailing entity has a proven attempt at a first address, they may have the ability to update an address and resend while if they identify an invalid address but do not have a proven attempt, they may need to send to the invalid address to show an attempt before updating the address.

Flagged addresses, and updated addresses for the flagged addresses if found, may be presented to mailing entity, for example, via a customer facing database portal such as Workspace 74. Such information may further be presented on a secure reporting website 76. In some embodiments, the information presented to the mailing entity may include one or more reports. A user at the mailing entity can log in to the database portal and pull reports about what was mailed, what was not mailed, what mail was returned, why it was returned, the old address and a new address if available.

A system and method for return mail processing thus may comprise creating a database, flagging profiles in the database based on data from physical and electronic returns, applying business rules against database, and updating information in the profiles based on searches for updated information, and creating reports using a reporting engine.

In some embodiments, the report may include a likelihood of success of delivery for addresses in profiles in the database. The likelihood may be reflected as a score (for example a score from 1 to 4) or a percentage. Business rules may then be applied saying that mail should only be sent based on a score of X or a percentage of X.

In general, business rules used in the system and method for return mail processing may be customized for different applications and may be specific to a mailing entity's needs. For example, some mailing entities may only be interested in mailing to people within a certain geographic region and a business rule for such entity thus may be “if someone has moved out of state, do not re-mail, flag the record and send a report back.” Other possible business rules include “if we have mailed it and this is the second return, do not mail a 3rd time;” or “first we mail to the address provided by the client, if the mail is returned, we try to clean up with national change of address database, then try to clean with a proprietary change of address, if we cannot get a better address, we drop the profile.”

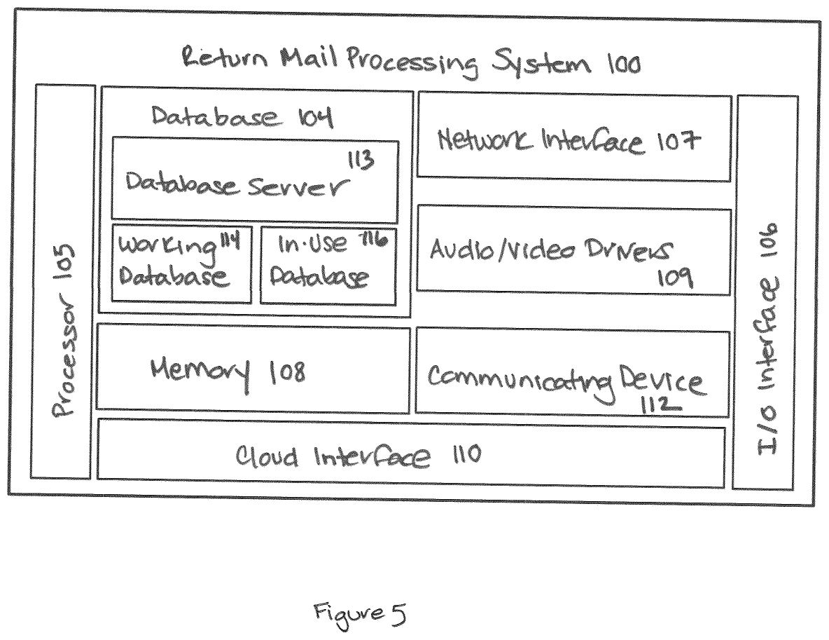

FIG. 5 illustrates a block diagram of a return mail processing system 100, in accordance with one embodiment. The return mail processing system 100 can include a combination of computer resources assets, including a database 104, a processor 105, an input-output (I/O) interface 106, a network interface 107, a memory 108, an audio and video driver 109, a transceiver, and the like. The return mail processing system 100 can include a cloud interface 110, which can be configured to communicate with one or more remote server. The return mail processing system 100 can be configured to initialize a communication session with a communicating device 112, to receive an incoming communication from the communicating device 112, or transmit an outgoing communication to the communicating device 112.

The database 104 can include a database server 113. In some embodiments, the database 104 may include a working database 114 and an in-use database 116. The in-use database 116 may be the database that is used for mailings. The working database 114 may be a database that is in process of updates and that can be used to replace the working database upon approval or finalization of an update.

Any of the computer resources assets can be interconnected using various communication links, including buses, and can be mounted on a common motherboard or provided as separate computing devices. The return mail processing system 100, including any of the computer resource assets contained in the system, can be configured to perform each process discussed herein.

The processor 105 can be arranged to process instructions for execution, including instructions stored in the memory. The processor can be arranged to generate and send or display graphical information for a graphic user interface (GUI) on a display screen, including, for example, an external input/output computer resource asset such as a computing device that can be coupled to a communication system via a communication link such as, for example, over a network. In other implementations, multiple processors or multiple buses can be used, as appropriate, along with multiple memories and types of memory. The computer resource asset can be connected with any computer resource asset in a user environment and arranged to provide portions of the necessary operations, such as, for example, a server bank, a group of blade servers, or a multi-processor system.

The processor 105 can include any of various commercially available processors. The processor can include a computing device. Dual microprocessors and other multi-processor architectures can be employed as the processor. The processor can include a central processing unit (CPU) or a graphic processing unit (GPU). The processor can be arranged to interact with any of the computer resource assets in the communication system to carry out or facilitate with the processes described herein.

Any of the computer resources contained in the return mail processing system 100 can be communicatively coupled to a bus. The bus can include any of several types of bus structures that can further interconnect to a memory bus (with or without a memory controller), a peripheral bus, and a local bus using any of a variety of commercially available bus architectures.

The memory 108 can include a read-only memory (ROM), a random-access memory (RAM), a hard disk drive (HDD), an optical disk drive (ODD), and a database (DB). The memory can provide nonvolatile storage of data, data structures, and computer-executable instructions, and can accommodate the storage of any data in a suitable digital format. The memory can include a computer-readable medium that can hold executable or interpretable computer code (or instructions) that, when executed by the processor, cause the steps, processes and methods in this disclosure to be carried out. The computer-readable medium can be contained in the memory, and can include sections of computer code contained in a non-transitory medium.

A basic input-output system (BIOS) can be stored in the ROM, which can include, for example, a non-volatile memory, an erasable programmable read-only memory (EPROM), or an electrically erasable programmable read-only memory (EEPROM). The BIOS can contain the basic routines that help to transfer information between any one or more of the computing resource assets, such as during start-up.

The RAM can include dynamic random-access memory (DRAM), a synchronous dynamic random-access memory (SDRAM), a static random-access memory (SRAM), a nonvolatile random-access memory (NVRAM), or another high-speed RAM for caching data.

The HDD can include, for example, an enhanced integrated drive electronics (EIDE) drive, a serial advanced technology attachments (SATA) drive, or any suitable hard disk drive for use with big data. The HDD can be configured for external use in a suitable chassis. The ODD can be arranged to read or write from or to a compact disk (CD)-ROM disk, or, read from or write to other high capacity optical media such as a digital versatile disk (DVD). The HDD or ODD can be connected to the bus by a hard disk drive interface and an optical drive interface, respectively. The hard disk drive interface can include a Universal Serial Bus (USB), an IEEE 1394 interface, and the like, for external applications.

The database 104 can store machine learning (ML) training datasets and ML testing datasets for building and/or training a machine learning (ML) model. In an embodiment, one or more of the computer resource assets can include a machine learning platform that can be configured to build a machine learning model and train the ML model to perform the operations disclosed herein. The ML model can be trained to analyze audible, visual, textual or other content. The ML model can be loaded, for example, into the RAM, and run by the processor executing computer resource processes on the ML platform. The training datasets can be updated periodically (or continuously) with updated parametric values, such as, for example, during parametric tuning of the ML model.

The memory 108 can be arranged to provide mass storage, for example, in the database 104. The memory can include a database server storage. The memory can contain a computer-readable medium, such as a solid-state drive (SSD), a hard disk device, an optical disk device, a flash memory or other similar solid-state memory device, or an array of devices, including devices in a storage area network or other configurations.

A computer program product can be tangibly embodied in a non-transitory computer-readable medium, which can be contained in the memory. The computer program product can contain instructions that, when executed, perform one or more methods or operations, such as those included in this disclosure. The computer-readable medium can include an information carrier such as the memory or memory on processor.

Any number of computer resources can be stored in the memory, including, for example, a program module, an operating system, an application program, an application program interface (API), or program data. The computing resource can include an API such as, for example, a web API, a simple object access protocol (SOAP) API, a remote procedure call (RPC) API, a representation state transfer (REST) API, or any other utility or service API. Any (or all) of the operating system, application programs, APIs, program modules, and program data can be cached in the RAM as executable sections of computer code.

The API can include an API for a markup language such as, for example, SGML, SVG, HTML, XHTML/XML), XUL, or LaTeX.

The API can include an API for a style sheet language, such as, for example, CSS, DSSSL, or XSL. The API can include a web-based API, an operating system API, a database system API, a computer hardware API, or a library API. The API can include, for example, one or more of the APIs available at <<https://developers.google.com>>.

The API can include one or more APIs that connect webpages to scripts or programing languages, including modelling (for example, SGML, SVG, HTML, XHTML/XML, XUL) documents as objects.

The API can include a document object model (DOM) API, such as for HTML or XML (for example, DOM5 HTML), that can create object-oriented representations of AV content that can be modified with a scripting module. A DOM can include a cross-platform and language-independent convention for representing and interacting with objects in HTML, XHTML/XML, SGML, SVG, or XUL.

The network interface 107 can be connected to a network, which can include the internet. The network interface can include a wired or a wireless communication network interface or a modem. When used in a local area network (LAN), the computer resource asset can be connected to the LAN network through the wired or wireless communication network interface, and when used in a wide area network (WAN), the computer resource asset can be connected to the WAN network through the modem. The modem can be internal or external and wired or wireless. The modem can be connected to the system bus via, for example, a serial port interface. The network interface can include a receiver, a transmitter or a transceiver.

The input-output (TO) interface 106 can receive commands or data from an operator via a user interface, such as, for example, a keyboard, a mouse, a pointer, a stylus, a microphone, a speaker, or a display device. The received commands and data can be forwarded from the IO interface as instruction to data signals, via the bus, to any of suitable computer resource asset.

The audio driver and a video driver may be provided as a driver suite. The audio driver can include a sound card, a sound driver, an interactive voice response (IVR) unit, or any other device necessary to render a sound signal on a sound production device, such as for example, a speaker. The video driver can include a video card, a graphics driver, a video adaptor, or any other device necessary to render an image signal on a display device.

The terms “a,” “an,” and “the,” as used in this disclosure, means “one or more,” unless expressly specified otherwise.

The term “backbone,” as used in this disclosure, means a transmission medium that interconnects one or more computing devices or communicating devices to provide a path that conveys data signals and instruction signals between the one or more computing devices or communicating devices. The backbone can include a bus or a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The terms “communicating device” and “communication device,” as used in this disclosure, mean any hardware, firmware, or software that can transmit or receive data packets, instruction signals, data signals, optical signals, sound signals, radio frequency signals or electromagnetic signals over a communication link. The device can include a computer or a server. The device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G, or 5G cellular standards, or Bluetooth. A communication link can include, for example, an RS-232, RS-422, RS-485, or any other suitable serial interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device” or “processor” can include, for example, without limitation, a communicating device, a computer resource, a processor, a microprocessor (μC), a central processing unit (CPU), a graphic processing unit (GPU), an application specific integrated circuit (ASIC), a general purpose computer, a super computer, a personal computer, a laptop computer, a palmtop computer, a notebook computer, a desktop computer, a workstation computer, a server, a server farm, a computer cloud, or an array or system of processors, μCs, CPUs, GPUs, ASICs, general purpose computers, super computers, personal computers, laptop computers, palmtop computers, notebook computers, desktop computers, workstation computers, or servers.

The terms “computing resource” or “computer resource,” as used in this disclosure, means software, a software application, a web application, a web page, a computer application, a computer program, computer code, machine executable instructions, firmware, or a process that can be arranged to execute on a computing device as one or more processes.

The terms “computer asset,” “computing resource asset” or “computer resource asset,” as used in this disclosure, means a computing resource, a computing device or a communicating device.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random-access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “cloud,” which can include a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, 0G, 1G, 2G, 3G, 4G, or 5G cellular standards, or Bluetooth.

The term “database,” as used in this disclosure, means any combination of software or hardware, including at least one computing resource or at least one computer. The database can include a structured collection of records or data organized according to a database model, such as, for example, but not limited to at least one of a relational model, a hierarchical model, or a network model. The database can include a database management system application (DBMS). The at least one application may include, but is not limited to, a computing resource such as, for example, an application program that can accept connections to service requests from communicating devices by sending back responses to the devices. The database can be configured to run the at least one computing resource, often under heavy workloads, unattended, for extended periods of time with minimal or no human direction.

The terms “including,” “comprising” and their variations, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or the like, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software or hardware, including at least one computing resource or at least one computer to perform services for connected communicating devices as part of a client-server architecture. The at least one server application can include, but is not limited to, a computing resource such as, for example, an application program that can accept connections to service requests from communicating devices by sending back responses to the devices. The server can be configured to run the at least one computing resource, often under heavy workloads, unattended, for extended periods of time with minimal or no human direction. The server can include a plurality of computers configured, with the at least one computing resource being divided among the computers depending upon the workload. For example, under light loading, the at least one computing resource can run on a single computer. However, under heavy loading, multiple computers can be required to run the at least one computing resource. The server, or any if its computers, can also be used as a workstation.

The terms “send,” “sent,” “transmission,” or “transmit,” as used in this disclosure, means the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A method for return mail processing comprising:
building a database of profiles, wherein each profile has an associated input address;
reviewing the input addresses for accuracy;
identifying an input address needing correction;
revising any identified input address such that all addresses in the database are standardized addresses;
mailing a mailpiece to a standardized address;
receiving a returned mailpiece having an associated undeliverable standardized address;
making a post-return recommendation regarding the profile with the undeliverable standardized address.

2. The method of claim 1, wherein the post-return recommendation is to revise the undeliverable standardized address to a revised address and further comprising revising the undeliverable standardized address to the revised address.

3. The method of claim 2, wherein a search for a correct address is done for the returned mailpiece and wherein the revised address is the correct address.

4. The method of claim 1, where the post-return recommendation is to delete the profile with the undeliverable standardized address.

5. The method of claim 1, wherein reviewing the input addresses for accuracy comprises confirming that each input address includes all necessary address information.

6. The method of claim 1, wherein revising the profile with the undeliverable standardized address is based on business rules.

7. The method of claim 5, wherein the business rules are geography specific.

8. The method of claim 7, wherein the business rule is that if a person associated with a profile has moved out of a geographic region, the profile is deleted from the database.

9. The method of claim 5, wherein the business rule is that a mailpiece is sent to an undeliverable standardized address at least two times before the profile is deleted.

10. The method of claim 1, wherein revising the undeliverable standardized address is done using information from a USPS Secure Data Feed, Move Updates, or NIXIE label.

11. The method of claim 1, wherein the database includes a working database and an in-use database.

12. A method for return mail processing and lifecycle data hygiene, the method comprising:
building a database of profiles, wherein each profile has an associated input address;
pre-mailing sorting, wherein pre-mailing sorting comprises:
reviewing the input addresses for accuracy;
identifying an input address needing correction;
revising any identified input address such that all addresses in the database are standardized addresses;
mailing a mailpiece to a standardized address; and
post-mailing updating, wherein post-mailing updating comprises:
receiving a returned mailpiece having an associated undeliverable standardized address;
revising the profile with the undeliverable standardized address;
wherein the database is used by a plurality of mailing entities.

13. The method of claim 12, wherein revising the profile with the undeliverable standardized address comprises deleting the profile from the database.

14. The method of claim 12, wherein revising the profile with the undeliverable standardized address comprises revising the undeliverable standardized address to a revised address.

15. The method of claim 14, wherein a search for a correct address is done for the returned mailpiece and wherein the revised address is the correct address.

16. A method for return mail processing comprising:
building a database of reference addresses;
developing a mailing list of recipient addresses;
checking the mailing list against the database of addresses and flagging recipient addresses that do not match a reference address;
mailing a plurality of pieces of mail, each of the plurality of pieces of mail being addressed to recipient addresses in the mailing list;
receiving a plurality of pieces of returned mail either physically or electronically;
identifying and flagging the recipient address of each of the plurality of pieces of returned mail; and
using business rules to process the flagged recipient addresses.

17. The method of claim 16, wherein building the database of addresses comprises inputting a plurality of profiles, each profile having an associated address.

18. The method of claim 16, wherein processing the flagged recipient addresses comprises searching for updated addresses.

19. The method of claim 18, further comprising updating a reference address corresponding to a flagged recipient address with the updated address for the flagged recipient address.

20. The method of claim 19, further comprising resending the piece of mail to the updated address.
